(19) United States
(12) Patent Application Publication
(10) Pub. No.: US 2010/0066619 A1
(43) Pub. Date: Mar. 18, 2010

(54) MAGNETIC COUPLING DEVICE AND READING DEVICE

(76) Inventors: Yuji Furumura, Yokohama-shi (JP); Naomi Mura, Tokyo (JP); Shinji Nishihara, Tokyo (JP); Katsuhiro Fujino, Yokohama-shi (JP); Katsuhiko Mishima, Yokohama-shi (JP); Susumu Kamihashi, Yokohama-shi (JP)

Correspondence Address: FOLEY & LARDNER LLP, 150 EAST GILMAN STREET, P.O. BOX 1497, MADISON, WI, 53701-1497, US

(21) Appl. No.: 12/516,648

(22) PCT Filed: Nov. 26, 2007
(86) PCT No.: PCT/JP2007/072752

§ 371 Date: Nov. 5, 2009

(30) Foreign Application Priority Data
Nov. 29, 2006 (JP) 2006-321096

(51) Int. Cl. H01Q 11/12

(52) U.S. Cl. 343/742

(57) ABSTRACT

A magnetic coupling device that supplies a high-frequency electromagnetic field appropriate for sensing and reading of information to a fine magnetic coupling circuit component contained in/added to individual banknotes, securities, or any other valuable sheet-like or plate-like objects, ensures sufficient magnetic coupling, and supplies sufficient electric power; and a reading device having equivalent functions are provided.

A scanning probe (a magnetic coupling device) 100 is a magnetic coupling device having a loop antenna for generation of a high-frequency electromagnetic field that resonates with and senses a tank circuit built into a fine magnetic coupling circuit component, and the loop antenna has a dielectric substrate 101, a first loop antenna 102A formed on the foreside of the dielectric substrate, a second loop antenna 102B formed on the backside of the dielectric substrate so as to be located in the same position and have the same diameter as the first loop antenna, and junctions (through holes) 108 and 110 connecting the first loop antenna and the second loop antenna in series.

### TECHNICAL FIELD

The present invention relates to a magnetic coupling device that is collectively used as RF powder and contained in/added to banknotes or the like to enable reading of information thereof using an external high-frequency magnetic field, and a reading device configured using such a magnetic coupling device.

### BACKGROUND ART

Nowadays, IC tags are considered products taking people to the ubiquitous era and they have been developed for use as RF-ID (radio frequency identification) in nametags, Suica cards, FeRAM cards, or the like. The technology of RF-ID may also be used to identify banknotes, securities, and other valuable documents. Forgery of banknotes is one of social problems, and a method that is a potential solution to such problems is to embed IC tags in banknotes or the like.

From IC tag chips, 128-bit memory data is read using microwaves of 2.45 GHz frequency (e.g., see Non-patent Document 1). In addition, there is already a radio frequency automatic identification (RF/AID) system for identification of banknotes, credit cards, or the like using a component other than IC tags. Patent Document 1 discloses an example of such a system, which has a plurality of resonators that are arranged in a predetermined pattern on a substrate made of paper, plastic, or any other material, occupy random spatial positions on the substrate, and resonate with a plurality of radio frequencies.

An example of a known radio frequency ID (RFID) device is described with reference to FIG. 25. This radio frequency ID device has a reader/writer 702 provided on, for example, a ticket gate 701, and a noncontact IC card that each user has. When passing through the gate 701, the user holds the noncontact IC card 703 over the reader/writer 702. Then, a magnetic field 704 makes a coulpling relationship by electromagnetic induction between the reader/writer 702 and the noncontact IC card 703 for sending/receiving of information (communication) and transmission of electric power. The magnetic field 704 is generated by a loop antenna built into the reader/writer 702, as schematically shown in FIG. 25. The noncontact IC card 703 acts as a ticket, a commuter pass, a cash card, a credit card, or the like.

A configuration of the noncontact IC card 703 is shown in FIG. 26. The noncontact IC card 703 has a semiconductor chip 705, which is fixed on a card substrate 706. In addition, the semiconductor chip 705 incorporates an IC circuit. In a typical configuration, a loop-like transmitting and receiving antenna 707 is formed on the card substrate 706 using a technique for making a printed circuit board. The transmitting and receiving antenna 707 is connected to the semiconductor chip 705 via bonding wires 708. The length of the transmitting and receiving antenna 707, which is formed on the card substrate 706, is usually adjusted to correspond to the wavelength of the transmission and reception frequency to maximize the efficiency of transmission and receiving.

Patent Document 1: Japanese Unexamined Patent Application Publication No. H10-171951

Non-patent Document 1: Mitsuo Usami, An ultrasmall RFID chip: μ-chip, OYO BUTURI, Vol. 73, No. 9, p. 1179-1183 (2004)

### DISCLOSURE OF INVENTION

### Problems to be Solved by the Invention

Recently, a banknote authentification system has been proposed as a new application field of radio frequency ID devices. In this system, a semiconductor chip like the semiconductor chip 705 described above is added to printing ink, and this printing ink is used to print banknotes with required information. Then, a reader/writer installed at an appropriate place senses banknotes produced in this way via noncontact radio communication to read the information stored in a memory of the semiconductor chip 705 and authentificates the banknotes.

However, this banknote authentification system has the following practical problems.

First, a banknote cannot hold an antenna on itself and accordingly the surface of a semiconductor chip is chosen as a place to form a loop antenna on. As a result, the antenna is very small and magnetic coupling between the antenna and a reader/writer is difficult. Therefore, radio communication cannot be easily established.

Second, the semiconductor chip has an IC circuit and thus there is a limit as to how much its size can be reduced. The lower limit of the size is, for example, approximately 400 μm (0.4 mm). Therefore, even if it is possible to add such semiconductor chips to banknotes using printing ink containing them, the banknotes have unusual projections on their surfaces and thus are unfavorable to the use.

To make such a banknote authentification system more practical, it is desired that the size of semiconductor chips like the one above be further reduced.

To address the problems described above, the present invention provides a magnetic coupling device that magnetically couples with a fine circuit component contained in/added to individual banknotes, securities, or any other valuable sheet-like or plate-like objects, thereby generating a high-frequency electromagnetic field appropriate for reading information and supplying sufficient electric power; and a reading device having equivalent functions.

### Means for Solving the Problems

The magnetic coupling device and the reading device according to the present invention are configured as follows to achieve the objective described above.

The first magnetic coupling device is a magnetic coupling device having a loop coil for generation of a high-frequency electromagnetic field that resonates with a fine powdery tank circuit (hereinafter, it is referred to as a “loop antenna”), wherein the loop antenna has a dielectric substrate, a first loop antenna formed on the foreside of the dielectric substrate, a second loop antenna formed on the backside of the dielectric substrate so as to be located in the same position and have the same diameter as the first loop antenna, and junctions connecting the first loop antenna and the second loop antenna in series.

In this configuration, the foreside of the dielectric substrate has a first terminal pattern to which a signal line conductor of a power feeder is connected and a second terminal pattern to which an earth conductor of the power feeder is connected, and the first terminal pattern is connected to an input terminal of the first loop antenna and the second terminal pattern is connected to an output terminal of the second loop antenna through a through hole.

In the configuration described above, the first loop antenna and the second loop antenna have a helical structure.

Furthermore, in the configuration described above, a plurality of antenna units each consisting of the first loop antenna and the second loop antenna are arranged on the foreside of the dielectric substrate.

In the configuration described above, the antenna units are arranged on the foreside of the dielectric substrate in such a manner that monitoring areas of the individual antenna units have no gap therebetween in the direction of arrangement. In addition, the diameter of the first loop antenna and the second loop antenna is almost equal to that of a magnetic coupling coil of the tank circuit.

The second magnetic coupling device is a magnetic coupling device having a loop antenna that generates a high-frequency electromagnetic field for resonance with a tank circuit, wherein the loop antenna has a bilayer dielectric substrate having a first substrate layer and a second substrate layer, a first loop antenna formed on the foreside of the first substrate layer, a second loop antenna formed on the backside of the first substrate layer, a third loop antenna formed on the foreside of the second substrate layer, a fourth loop antenna formed on the backside of the second substrate layer, and junctions connecting the four loop antennas, i.e., the first to fourth loop antennas, in series; and the four loop antennas, i.e., the first to fourth loop antennas, have the same diameter and are superposed on each other so as to be located at the same position.

In this configuration, the foreside of the first substrate layer of the dielectric substrate has a first terminal pattern to which a signal line conductor of a power feeder is connected and a second terminal pattern to which an earth conductor of the power feeder is connected, and the first terminal pattern is connected to an input terminal of the first loop antenna and the second terminal pattern is connected to an output terminal of the fourth loop antenna through a through hole.

In the configuration described above, the four loop antennas, i.e., the first to fourth loop antennas, have a helical structure.

Meanwhile, in the configuration of the first magnetic coupling device described earlier, the foreside of the dielectric substrate has a first transmitting terminal pattern to which a signal line conductor of a transmitting power feeder is connected, a first receiving terminal pattern to which a signal line conductor of a receiving power feeder is connected, and a second terminal pattern to which an earth conductor of the transmitting power feeder and an earth conductor of the receiving power feeder are connected, and any of the first transmitting terminal pattern and the first receiving terminal pattern is connected to an input terminal of the first loop antenna via a switch and the second terminal pattern is connected to an output terminal of the second loop antenna through a through hole.

The third magnetic coupling device is a magnetic coupling device having means for generating high-frequency magnetic fields resonating with individual tank circuits built into a plurality of magnetic coupling circuit components, the magnetic coupling circuit components being added to a sheet member with a plurality of sectors and corresponding to the individual sectors, and a plurality of transmission line sector monitors arranged on the foreside of a dielectric plate substrate in a line, wherein each transmission line sector monitor has a transmission line pattern and an earth pattern formed on the foreside of the dielectric substrate.

In this configuration, the sheet member is a banknote.

The reading device according to the present invention has any of the magnetic coupling devices described above as a scanning probe, and reads frequency information from a monitoring object having powder particles (magnetic coupling circuit components) with the use of resonance caused by this scanning probe.

### Advantages

The magnetic coupling device and the reading device according to the present invention have the following advantageous effects.

First, in inspections of RF-powder-containing bases, such as banknotes, or any other application, they provides a fine scanning probe that generates high-frequency magnetic fields having several frequencies for resonance with tank circuits built into RF powder particles (magnetic coupling circuit components) and has a size almost equal to that of the tank circuits, thereby enabling reading of frequency information from each RF powder particle in a stable and accurate manner.

Second, magnetic coupling based on resonance with tank circuits is used for reading frequency information from RF powder particles and thus no IC circuit is required in the RF powder particles and the frequency information can be read in an efficient manner.

Third, the magnetic coupling device and the reading device according to the present invention read frequency information using magnetic coupling based on a contact state, and thus does not disturb other communication lines by leakage of high-frequency waves.

### BEST MODE FOR CARRYING OUT THE INVENTION

Preferred embodiments of the present invention are described below with reference to the attached drawings.

First, a magnetic coupling circuit component to which the magnetic coupling device and the reading device according to the present invention are applied is described with reference to FIGS. 1 to 5. In the following explanations of embodiments, the term “magnetic coupling circuit component” represents an RF powder particle equipped with a coil that induces electromagnetic induction when coupling with a high-frequency electromagnetic field (RF), and a collective entity thereof constitutes RF powder.

FIG. 1 is an oblique cross-sectional view of an RF-powder-containing base. The RF-powder-containing base means a base that contains RF powder.

FIG. 1 is an enlarged view of a sheet base 10 such as a banknote containing, for example, three kinds of RF powder particles 11, 12, and 13. The RF powder particles 11 to 13 individually have a property of coupling with high-frequency magnetic fields of different frequencies. The RF powder particles 11 to 13 shown in FIG. 1 have different sizes, and this illustrates that the RF powder particles 11 to 13 couple with magnetic fields of different frequencies; however, in fact, the RF powder particles 11 to 13 have almost the same size.

In practice, the numbers of the RF powder particles 11 to 13 are much more and a multiplicity of or a large amount of the RF powder particles are collectively used as a powdery entity, thereby composing RF powder. The total number of the RF powder particles 11 to 13 shown in FIG. 1 is thirteen, but the number of RF powder particles is not limited to this number. Considering that the RF powder is used as a powdery entity, the RF powder particles 11 to 13 are, in fact, in a dispersed state while spreading over the entire body of the sheet base 10. A base 10 retaining a large amount of RF powder in its inside, on its surface, or any other portion as described above is referred to as an “RF-powder-containing base 10.”

In addition, the RF powder particles 11 to 13 may be added to printing ink and added/attached to a surface of a base 10 by printing.

Meanwhile, the term “RF powder” mentioned above represents powder (a powdery entity or powder particles) that is composed of a large amount of particles each having an electric circuit component that transmits electromagnetic energy to an external reader and receives it from the reader with the use of magnetic coupling initiated by radio transmission (a high-frequency electromagnetic field: RF), and usually used as a collective entity.

Next, an example of an RF powder particle that acts as a component of RF powder is described with reference to FIGS. 2 to 5.

FIG. 2 is an oblique view of the appearance of an RF powder particle, FIG. 3 is a plan view of the RF powder particle, FIG. 4 is a cross-sectional view showing the cross-section along the line A-A in FIG. 3, and FIG. 5 is a cross-sectional view showing the cross-section along the line B-B in FIG. 3. In these vertical cross-sectional views, FIGS. 4 and 5, the thickness of the RF powder particle is shown as magnified.

The RF powder particle 21 preferably has a three-dimensional shape like a cube or a similar plate-like rectangular solid. On the rectangular planes composing the outer surface of the particle, the dimensions of ones including the longest edges are preferably 0.30 millimeters square or smaller, and more preferably 0.15 millimeters square or smaller. The RF powder particle 21 in this embodiment is, as shown in FIG. 3, formed so that the planes thereof have a square shape. The length of each edge L of these square planes of the RF powder particle 21 shown in FIG. 3 is, for example, 0.15 mm (150 μm).

On the RF powder particle 21, an insulating layer 23 (e.g., SiO₂) is formed on a substrate 22 composed of silicon (Si) or the like. On the insulating layer 23, a coil 24 (an inductance component) and a condenser (or a capacitor) 25 (a capacitance component) are formed using a film-forming technique. The thickness of the insulating layer 23 is, for example, approximately 10 μm. The condenser 25 consists of two components 25a and 25b.

The coil 24 and the condenser 25 formed on the insulating layer 23 couple with a high-frequency magnetic field having a specific frequency (e.g., 2.45 GHz). As shown in FIG. 2 or 3, the coil 24 is formed by coiling a conductive wire to make, for example, three turns along the edges of a square plane of the RF powder particle 21. An example of the material of the coil 24 is copper (Cu). Both ends of the coil 24 are square pads 24a and 24b having a desired area. These two pads 24a and 24b are positioned at an inner position and an outer position such that a part of the coil 24 is positioned so as to cross therebetween. The line between the two pads 24a and 24b is perpendicular to the crossing part of the coil 24. The pad 24a acts as an upper electrode of the component 25a of the condenser 25, whereas the pad 24b acts as an upper electrode of the component 25b of the condenser 25.

In the configuration described above, the number of turns, length, and shape of the coil 24 may be arbitrarily designed.

The condenser 25 in this embodiment consists of, for example, two condenser components 25a and 25b. The condenser component 25a has an upper electrode 24a and a lower electrode 26a (e.g., aluminum (Al)) and an insulating film 27 (e.g., SiO₂) inserted therebetween. The upper electrode 24a and the lower electrode 26a have similar electrode shapes, and are electrically isolated by the insulating film 27. On the other hand, the condenser component 25b has an upper electrode 24b and a lower electrode 26b and the insulating film 27 inserted therebetween. As with their counterparts, the upper electrode 24b and the lower electrode 26b have similar electrode shapes, and are electrically isolated by the insulating film 27.

The lower electrode 26a of the condenser component 25a and the lower electrode 26b of the condenser component 25b are connected to each other through a conductive wire 26c. In practice, the two lower electrodes 26a and 26b and the conductive wire 26c are formed as an integrated unit. Meanwhile, the insulating film 27 is a monolayer insulating film common to both condenser components 25a and 25b, and has a thickness of, for example, 30 nm. The insulating film 27 electrically insulates the conductive wire 26c connecting the lower electrodes 26a and 26b to each other and the coil 24 in the region between the two condenser components 25a and 25b.

In the configuration described above, both ends of the coil 24 are connected to the condenser 25 consisting of the two condenser components 25a and 25b electrically connected in series. The coil 24 and the condenser 25, which are connected so as to make a loop, form a tank circuit (an LC resonance circuit). This tank circuit couples with a high-frequency magnetic field having a frequency that is equal to the resonance frequency thereof and resonates.

In addition, as is clear from FIGS. 4 and 5, all planes of the RF powder particle 21 are coated with a P—SiN film 28. The P—SiN film 28 protects the entire area of the surface of the RF powder particle 21 on which the tank circuit is formed.

In the configuration described above, the condenser 25 consists of the two condenser components 25a and 25b. However, it may consist of any one of the condenser components. The capacitance of the condenser 25 may be appropriately designed by changing the areas of the electrodes. In addition, a plurality of condensers may be used and arranged in parallel.

An RF powder particle 21 having the structure described above has a tank circuit consisting of a coil 24 and a condenser 25 connected to each other on an insulating surface of a substrate 22 so as to make a loop, and thus has a function of coupling with a high-frequency magnetic field determined by the resonance frequency of the tank circuit and resonating. In this way, the RF powder particle 21 acts as the above-mentioned “powdery circuit component” described earlier, which resonates when coupling with a magnetic field having a designed frequency.

In addition, the coil 24 and the condenser 25 formed on the insulating layer 23 have no electric connection with the surface of the substrate 22. Therefore, the insulating layer 23 deposited on the substrate 22 has no contact hole and no contact wiring. This means that the tank circuit consisting of the coil 24 and the condenser 25 is electrically isolated from the silicon substrate 22 and it acts as a resonance circuit alone and independently of the substrate 22.

In the RF powder particle 21 described above, the substrate 22 used as a base is a silicon substrate and has a surface coated with the insulating film 23. However, the substrate may be made of other dielectric substances (insulating substances), such as glass, resin, and plastic, instead of a silicon substrate. Substrates made of glass or any other insulating material would not require the special insulating film 23 because the material is an inherently insulating substance (dielectric substance).

Next, a method for inspecting (monitoring) an RF-powder-containing base 10 that contains RF powder particles 11 to 13 each having the structure described above and actions thereof during inspection are described with reference to FIGS. 6 to 8.

FIG. 6 shows a device configuration of an inspection device. As described above with reference to FIG. 1, the sheet base 10 like a banknote contains a considerable number of RF powder particles (11 to 13). In FIG. 6, the thickness of the base 10 is shown as magnified.

The base 10 is scanned with a reader 62 connected to a computer 61, and the computer 61 reads frequency-dependent response data of the RF powder particles 11. The computer 61 has a display unit 61a and a keyboard 61c for operation as well as a main unit 61b that processes the data.

The reader 62 has a scanning probe 63 (see FIGS. 7 and 8). This scanning probe 63 generates a high-frequency electromagnetic field therearound and couples with powder particles (RF powder particles 11 to 13) by magnetic coupling. For example, if the specific frequency of an RF powder particle is 2.45 GHz, a high-frequency electromagnetic field having the same frequency, 2.45 GHz, would resonate with the powder particle, and then the energy of the electromagnetic field is transmitted to the RF powder particle. For efficient transmission of this energy, it is necessary that the electromagnetic field generated by the scanning probe and the coil of each RF powder particle are close enough to couple with each other well. For efficient coupling of the two bodies in space, it is desirable that the coils of the bodies have almost the same size and the distance between them is almost equal to the size of the coils. Resonance can be confirmed by, for example, measuring reflectance because this parameter decreases in case of energy loss, more specifically, when energy transmitted to a circuit is not returned. To detect the specific frequency of the RF powder particle, 2.45 GHz, a frequency generated by the scanning probe 63 is changed within the range of, for example, 1 to 3 GHz. The reader 62 scans the surface of the base 10 to locate RF powder particles while a certain distance from the surface is kept constant so that magnetic coupling consistently occurs.

To read frequency information from each of the RF powder particles 11 to 13 contained in the base 10, the reader 62 scans the surface of the base 10 in a certain direction using the scanning probe 63 while changing the frequency for magnetic coupling within a particular frequency range. An actual structure of the scanning probe 63 may be one having a single probe device (a coil device) or one having a plurality of probe devices arranged in a desired pattern. The scanning probe 63 or probe device(s) used as a component of the scanning probe 63 has a function of generating a high-frequency electromagnetic field.

It should be noted that the reader 62 and the scanning probe 63 shown in FIGS. 6 to 8 are just conceptual diagrams and thus do not represent practical and specific structures thereof.

The scanning probe 63 described above corresponds to the “magnetic coupling device” according to the present invention, whereas the reader 62 corresponds to the “reading device” according to the present invention.

FIG. 7 is a schematic diagram showing a state where a scanning probe 63 of a reader 62 generates a high-frequency wave having a certain frequency, a resonance current flows in a coil of a tank circuit of an RF powder particle 11 whose specific vibration frequency is close to or equal to the frequency described above, and accordingly electromagnetic fields H are generated around the RF powder 11. This situation may be referred to as “sensing” in these explanations of embodiments. Each RF powder particle is much smaller than the wavelength (0.15 mm versus 15 cm when using, for example, a 2-GHz band), and thus irradiated components of electromagnetic waves are negligible. High-frequency energy is transmitted, reflected, and lost from the scanning probe by magnetic coupling.

FIG. 8 illustrates an RF powder particle 11 receiving and reflecting energy by magnetic coupling occurring at the position thereof. The reader 62 is in a scanning operation and the scanning probe 63 is located above the RF powder particle 11. The scanning probe 63 generates a high-frequency magnetic field having a frequency varying within a predetermined range therearound. When the frequency of the magnetic field gets close to or reaches the specific frequency of the RF powder particle 11, magnetic coupling occurs and a current having the same frequency flows in the tank circuit, consisting of a coil and a condenser, of the RF powder particle, thereby resulting in transmission of energy (the arrow 64 in FIG. 8). This current consumes a part of the transmitted (or “received”) energy to produce heat in the circuit. This consumed energy is an energy loss, which can be measured as a decrease in reflection (the arrow 65 in FIG. 8) using the scanning probe. The maximum energy loss, or the greatest decrease in reflection, is observed when the specific frequency is reached. The reader 62 shown in FIG. 6 detects the frequency at which resonance occurs during this measurement as the frequency data information of the RF powder particle 11, and sends it, together with the positional information of the scanning probe 63, to the computer 61. The computer 61 stores the frequency information and sends it as the base data if it is necessary.

While the reader 62 is in a scanning operation, the scanning probe 63 is located above the RF powder particle 12 as well. When the frequency of a high-frequency electromagnetic field generated by the scanning probe 63 reaches the frequency that would be sensed by the RF powder particle 12, the RF powder particle 12 couples with this high-frequency magnetic field and resonates, and thus the frequency information of the RF powder particle 12 is read in a manner like the one described above. Furthermore, while the reader 62 is in a scanning operation, the scanning probe 63 is located above the RF powder particle 13 as well. When the frequency of a high-frequency electromagnetic field generated by the scanning probe 63 reaches the frequency that would be sensed by the RF powder particle 13, the RF powder particle 13 couples with this high-frequency magnetic field and resonates, and thus the frequency information of the RF powder particle 13 is read.

Next, the first embodiment of the magnetic coupling device (scanning probe) and the reading device (reader) according to the present invention is described with reference to FIGS. 9 to 13.

FIG. 9 is an oblique view of a scanning probe, FIG. 10 is a cross-sectional view showing important components of the scanning probe, FIG. 11 is a plan view of the foreside of the scanning probe, FIG. 12 is an enlarged view of the foreside of a dielectric substrate mounted on the scanning probe, and FIG. 13 is an enlarged perspective view of the backside of the same dielectric substrate seen from the foreside.

The scanning probe 100 is composed of a dielectric substrate 101, a single electromagnetic loop pattern 102A formed on the upper foreside of the dielectric substrate 101, a single electromagnetic loop pattern 102B formed on the lower backside of the dielectric substrate 101, and a first terminal pattern 103 and a second terminal pattern 104 formed on the foreside of the dielectric substrate 101. The two electromagnetic loop pattern 102A and 102B formed on the foreside and backside, respectively, have a ring-like shape with a partial opening, share the same center, and have the same diameter. A coaxial line 105 connected to an external circuit supplies electric power. The central conductor 105a of the coaxial line 105 is connected to the terminal pattern 103 via a wire 106, and the external conductor 105b of the coaxial line 105 is connected to the terminal pattern 104 via a wire 107. The coaxial line 105 is positioned in the reader 62 described above. The coaxial line 105 supplies high-frequency electric power to the electromagnetic loop patterns 102A and 102B, and then the electromagnetic loop patterns 102A and 102B individually generate a high-frequency electromagnetic field.

The end of the central conductor 105a of the coaxial line 105 is connected to the terminal pattern 103 of the electromagnetic loop pattern 102A, and thus electric power supplied by the coaxial line 105 passes through the terminal pattern 103 and then reaches the electromagnetic loop pattern 102A. An output from the electromagnetic loop pattern 103A passes through a through hole (a contact hole) 108 of the other end and then reaches the electromagnetic loop pattern 102B formed on the backside of the dielectric substrate 101. An output from the electromagnetic loop pattern 102B on the backside passes through an output terminal pattern 109 and a through hole 110 and then reaches the second terminal pattern 104 on the foreside. The terminal pattern 104 has, as described above, a connection to an external conductor 105b of the coaxial line 105.

The electromagnetic loop patterns 102A and 102B described above constitutes a double-helical scanning probe 100, to which high-frequency electric power is supplied by the coaxial line 105. Such electromagnetic loop patterns 102A and 102B of the scanning probe 100, which have a coupling effect based on electromagnetic induction, are produced using a technique for making a printed circuit board so as to have a size almost equal to that of RF powder particles 11, magnetic coupling circuit devices, or the like. Meanwhile, the dielectric substrate 101 is formed using a flexible substrate or the like, and this allows the spacing between the foreside and backside electromagnetic loop patterns 102A and 102B to be a few tens of micrometers. The scanning probe 100 can be positioned in contact with RF powder particles 11 or the like and thus magnetic coupling between the reader 62 described above and RF powder particles 11 is strong.

Next, the second embodiment of the magnetic coupling device (scanning probe) and the reading device according to the present invention is described with reference to FIGS. 14 to 18.

FIG. 14 is an plain view of a scanning probe, FIG. 15 is a diagram showing the foreside of the first substrate layer of a dielectric substrate mounted on the scanning probe, FIG. 16 is a perspective view of the backside of the first substrate layer seen from the foreside, FIG. 17 is a diagram showing the foreside of the second substrate layer of the dielectric substrate mounted on the scanning probe, and FIG. 16 is a perspective view of the backside of the second substrate layer seen from the foreside.

The dielectric substrate 201 of the scanning probe 200 according to this embodiment has a multi-layer structure. Although the number of layers is arbitrary, an example using two layers is described in the explanation of this embodiment. Therefore, the dielectric substrate 201 of the scanning probe 200 has a bilayer structure consisting of a first substrate layer 201a as the upper layer and a second substrate layer 201b as the lower layer.

FIG. 14 is a drawing similar to FIG. 11 described earlier. In FIG. 14, components already shown in FIG. 11 are represented by the numerals used in that drawing. Therefore, FIG. 14 includes the numeral 103 representing a first terminal pattern, 104 representing a second terminal pattern, and 105 representing a coaxial line. The central conductor 105a of the coaxial line 105 is connected to the terminal pattern 103 via a wire 106, and the external conductor 105b of the coaxial line 105 is connected to the terminal pattern 104 via a wire 107. This configuration is the same as that of the first embodiment described earlier.

The dielectric substrate 201 consists of the first substrate layer 201a and the second substrate layer 201b. As shown in FIGS. 15 to 18, the foreside and backside of the first substrate layer 201a have electromagnetic loop patterns 202A and 202B, respectively, and the foreside and backside of the second substrate layer 201b have electromagnetic loop patterns 202C and 202D, respectively. These four electromagnetic loop patterns 202A to 202D have a ring-like shape with a partial opening, share the same center, and have the same diameter. As described below, the electromagnetic loop patterns 202A to 202D are electrically connected to adjacent pattern(s) to form a tetra-helical scanning probe 200.

As shown in FIG. 15, the first substrate layer 201a of the dielectric substrate 200 has the electromagnetic loop pattern 202A and the terminal patterns 103 and 104 on its foreside, as well as four through holes 203a, 203b, 203c, and 203d. One end of the ring-like electromagnetic loop pattern 202A is connected to the terminal pattern 103, whereas the other end is connected to the first through hole 203a. The fourth through hole 203d is connected to the terminal pattern 104.

As shown in FIG. 16, one end of the electromagnetic loop pattern 202B formed on the backside of the first substrate layer 201a is connected to the first through hole 203a, whereas the other end is connected to the second through hole 203b.

As shown in FIG. 17, one end of the electromagnetic loop pattern 202C formed on the foreside of the second substrate layer 201b is connected to the second through hole 203b, whereas the other end is connected to the third through hole 203c. Furthermore, as shown in FIG. 18, one end of the electromagnetic loop pattern 202D formed on the backside of the second substrate layer 201b is connected to the third through hole 203c, whereas the other end is connected to the fourth through hole 203d.

These four electromagnetic loop patterns 202A to 202D form a tetra-helical scanning probe 200. High-frequency electric power supplied by the central conductor of the coaxial line 105 is transmitted through the electromagnetic loop patterns in the order 202A, 202B, 202C, 202D, and then passes through the fourth through hole 202d and the terminal pattern 104 and reaches the external conductor of the coaxial line 105. In this way, the scanning probe 200 generates a strong high-frequency electromagnetic field.

Next, the third embodiment of the magnetic coupling device (scanning probe) and the reading device according to the present invention is described with reference to FIG. 19. FIG. 19 is a plan view of the foreside of a scanning probe and is similar to FIG. 11.

The scanning probe 300 according to this embodiment shown in FIG. 19 is a variation of the scanning probe 100 according to the first embodiment. Therefore, in FIG. 19, components already described in the first embodiment are represented by the numerals used in that embodiment.

The dielectric substrate 101 of the scanning probe 300 has an electromagnetic loop pattern 102A on its foreside, and has an electromagnetic loop pattern 102B like the one above on its backside. Furthermore, the scanning probe 300 has two first terminal patterns 103a and 103b on the foreside of the dielectric substrate 101. The second terminal pattern 104 is larger than that used in the first embodiment and has an axisymmetric shape. This second terminal pattern 104 has two through holes 301 and 302. Since the two first terminal patterns 103a and 103b are formed, a transmission/receiving switch 303 is placed at one end of the electromagnetic loop pattern 103A. This transmission/receiving switch 303 is used to choose which of the two terminal patterns 103a and 103b is connected to the end of the electromagnetic loop pattern 103A. Meanwhile, the output terminal pattern 304 of the electromagnetic loop pattern 103b formed on the backside of the dielectric substrate 101 is connected to the second terminal pattern 104 via the two through holes 301 and 302 described above.

This scanning probe 300 comes with two coaxial lines 105-1 and 105-2. The central conductor of one coaxial line 105-1 is connected to one first terminal pattern 103a via a wire 106, whereas the external conductor of the coaxial line 105-1 is connected to the second terminal pattern 104 via a wire 107. On the other hand, the central conductor of the other coaxial line 105-2 is connected to the other first terminal pattern 103b via the wire 106, whereas the external conductor of the coaxial line 105-2 is connected to the second terminal pattern 104 via the wire 107. The coaxial line 105-1 is a coaxial line for transmission, whereas the coaxial line 105-2 is a coaxial line for receiving. The second terminal pattern 104 is an earth terminal pattern common to both coaxial lines 105-1 and 105-2.

In the scanning probe 300 having the configuration described above, the transmission/receiving switch 303 is used to switch the connection between that to the transmission coaxial line 105-1 via the terminal pattern 103a and that to the receiving coaxial line 105-2 via the terminal pattern 103a. This transmission/receiving switch 303 is formed on the basis of a switching function of a semiconductor device. A command signal ordering the transmission/receiving switch 303 to switch the connection is supplied by an external circuit.

Next, the fourth embodiment of the magnetic coupling device (scanning probe) and the reading device according to the present invention is described with reference to FIG. 20. FIG. 20 is a plan view of the foreside of a scanning probe and is the same as FIG. 19. In FIG. 20, components already described in any of the embodiments are represented by the numerals used in that embodiment. The scanning probe according to this embodiment is an example having more electromagnetic loop patterns than that according to the third embodiment.

The scanning probes 100 to 300 described earlier achieve strong magnetic coupling between the electromagnetic loop patterns thereof and a magnetic coupling circuit component (an RF powder particle 11) when these two members are in a predetermined positional relationship like one shown in FIGS. 9 and 10. However, to fulfill these conditions, it is necessary to locate a magnetic coupling circuit component (an RF powder particle 11) accurately as shown in FIG. 10.

In the scanning probe 400 according to this embodiment, the dielectric substrate 101 has, for example, eight units 401 arranged in an array on its foreside, and each of the units 401 consists of electromagnetic loop patterns 102A and 102B as well as the first and second terminal patterns related thereto. This scanning probe 400 comes with two coaxial lines 105-1 and 105-2.

The eight units 401, which are arranged on the foreside of the dielectric substrate 101 and individually include the electromagnetic loop pattern 102A, each have a transmission/receiving switch 303. Since the eight electromagnetic loop patterns 102A are arranged, the first transmitting terminal pattern 402, the first receiving terminal pattern 403, and the second terminal pattern 404 (terminal patterns 404a) are formed as patterns common to the eight electromagnetic loop patterns on the foreside of the dielectric substrate 101. In FIG. 20, the first terminal pattern 402 is formed so as to spread in the horizontal direction over the central area of the foreside of the dielectric substrate 101, and the second terminal pattern 403 is formed along the upper and lower edges on the foreside of the dielectric substrate 101. Regarding the second terminal pattern 404, the eight units 401 individually have a corresponding second terminal pattern 404a and these second terminal patterns 404a are eventually connected to the common terminal pattern 404. The terminal pattern 404 and the nine terminal patterns 404a are connected to each other on the backside of the dielectric substrate 101. As for coaxial lines, a transmitting coaxial line 105-1 and a receiving coaxial line 105-2 are provided. The central conductor of the transmitting coaxial line 105-1 is connected to the terminal pattern 403, whereas the central conductor of the receiving coaxial line 105-2 is connected to the terminal pattern 402. The external conductors of these two coaxial lines 105-1 and 105-2 are connected to the common second terminal pattern 404.

This scanning probe 400 has many electromagnetic loop patterns 102A (102B) arranged on a surface of a dielectric substrate 101. Thus, this scanning probe 400 exerts a magnetic coupling effect without accurating location of magnetic coupling circuit components (e.g., RF powder particles 11).

In the scanning probe 400 having eight electromagnetic loop patterns 102A, each transmission/receiving switch 303 is switched to the transmission side when a high-frequency electromagnetic field is supplied to magnetic coupling circuit components, and switched to the receiving side when a high-frequency electromagnetic field is returned from the magnetic coupling circuit components. The eight electromagnetic loop patterns 102A arranged on the scanning probe 400 are switched to either side as described above to prevent a high-frequency electromagnetic field generated by any of the electromagnetic loop patterns arranged in an array from being received by the other electromagnetic loop patterns.

FIG. 21 illustrates the fifth embodiment of the magnetic coupling device (scanning probe) and the reading device according to the present invention. FIG. 21 is a plan view of the foreside of a scanning probe and is similar to FIG. 20. The scanning probe according to this embodiment is a variation of the first to fourth embodiments. The scanning probe 500 according to this embodiment has six electromagnetic loop patterns 102A on the foreside of the dielectric substrate 101. On the other hand, the backside of the dielectric substrate 101 has six electromagnetic loop patterns 102B corresponding to the six electromagnetic loop patterns 102A. On the foreside of the dielectric substrate, three of the electromagnetic loop patterns 102A line up along the row 501, whereas the other three electromagnetic loop patterns 102A line up along the row 502 and are positioned so that the former three and the latter three are alternately arranged. Therefore, in the scanning probe 500 according to this embodiment, the pitch of electromagnetic loop patterns 102A arranged on the foreside of a dielectric substrate is narrow and thus no gap acting as a blind spot in inspection exists in the directions of the row 501 and other rows. In addition, the structure in which each of six electromagnetic loop patterns 105A has a coaxial line 105 is also characteristic to this embodiment. It should be noted that, in FIG. 21, components already described in any of the first to fourth embodiments are represented by the numerals used in that embodiment, and thus are not further explained.

The scanning probe 500 described above allows for a sufficiently narrow pitch of adjacent electromagnetic loop patterns, thereby enabling easy and stable magnetic coupling with magnetic coupling circuit components (e.g., RF powder particles 11).

Next, another embodiment of the reader (reading device) that reads information from a sheet-like RF-powder-containing base 10 is described. In this embodiment, the RF-powder-containing base 10 is a ten-thousand-yen banknote and the scanning probe (magnetic coupling device) incorporated in the reader is a transmission-line-based probe.

FIG. 22 is a schematic elevation view of a ten-thousand-yen banknote. On this ten-thousand-yen banknote 601, a plurality of (e.g., fourteen) RF powder particles (magnetic coupling circuit components) 602 are arranged, for example, in a line parallel to the shorter edges of the banknote. Addition of these fourteen RF powder particles 602 to the foreside of the ten-thousand-yen banknote 601 is achieved by, for example, adding the RF powder particles to printing ink and then printing the banknote with the obtained printing ink. The fourteen RF powder particles 602 are distributed to four sectors 603A, 603B, 603C, and 603D. The tank circuit of each RF powder particle 602 is designed to resonate with a specific frequency selected from ten resonance frequencies. These ten resonance frequencies are, for example, 1.0 GHz, 1.5 GHz, 2.0 GHz, 2.5 GHz, 3.0 GHz, 3.5 GHz, 4.0 GHz, 4.5 GHz, 5.0 GHz, and 5.5 GHz. It should be noted that the number and the shape of the sectors are not limited to those described above. The sectors may contain an area on which letters or the like are printed with printing ink.

In information reading testing of the ten-thousand-yen banknote 601 described above, ID information of the ten-thousand-yen banknote 601 is acquired on the basis of the combination of resonance frequencies of RF powder particles 602 added to the ten-thousand-yen banknote 601.

FIG. 23 shows a reader used to read frequency information of a plurality of RF powder particles 602 added to a ten-thousand-yen banknote 601. The reader 604 has a dielectric substrate and thus has a plate-like shape, and a surface of the dielectric substrate has four transmission line sector monitors 605A, 605B, 605C, and 605D arranged in a line. These four transmission line sector monitors 605A to 605D correspond to the above-described four sectors 603A to 603D, respectively, of the ten-thousand-yen banknote 601. Each of the transmission line sector monitors 605A to 605D consists of a transmission line pattern 606 and earth patterns 607 on both sides thereof. Feeder circuits and other electric circuits of the reader 604 are not shown in the drawing. Each of the transmission line sector monitors 605A to 605D generates a magnetic field around the straight portion of the transmission line pattern 606 when a predetermined high-frequency current is supplied to the transmission line pattern 606. On the surface of the reader 604, such a magnetic field is approximately perpendicular to the surface. In addition, the frequencies of high-frequency currents supplied to the transmission line patterns 606 of the four transmission line sector monitors 605A to 605D are changed as needed in consideration of the resonance frequencies of RF powder particles 11 added to a banknote to be monitored. In this way, the frequencies of high-frequency electromagnetic fields for resonance sensing are changed.

As shown in FIG. 23, a ten-thousand-yen banknote 601 is moved along the surface of the reader 604 having the configuration described above. The four transmission line sector monitors 605A to 605D built into the reader 604 monitor the fourteen RF powder particles 602 distributed in the corresponding sectors 603A to 603D, respectively, formed in the ten-thousand-yen banknote 601, sense the tank circuits of the individual RF powder particles 602, thereby reading frequency information of the RF powder particles.

The information of the ten-thousand-yen banknote 601 read by the reader 604 is frequency information related to the resonance frequency of each of the fourteen RF powder particles 602 added to the ten-thousand-yen banknote 601. The combination of the frequency information of the fourteen RF powder particles 602 read in this way is used to create coding data. This coding data is used to identify and monitor the ten-thousand-yen banknote 601.

The reader 604 described above is a one-sided reader having transmission line sector monitors on only one surface of its dielectric substrate. Several variations of this reader 604 are shown in FIG. 24. It should be noted that FIG. 24 (A) shows the reader 604 described above. In FIG. 24, (B) has a configuration in which earth conductors 608 are arranged on the entire backside of the substrate of the reader 604. This configuration strengthens magnetic coupling. Then, (C) has a structure in which two readers 604 face each other with a spacing 609 therebetween with the surfaces each having transmission line sector monitors facing each other. A ten-thousand-yen banknote 601 like the one above can pass through this spacing 609. This configuration further strengthens magnetic coupling. In addition, (D) has a configuration in which earth conductors 608 are arranged on the entire backside of the substrate of each reader 604 according to the configuration shown in (C).

The configurations, shapes, sizes, and positional relationships described in these embodiments are just outlines facilitating understanding and implementation of the present invention. Therefore, the present invention is not limited to the embodiments described above and many modifications and variations can be made to the present invention without departing from the scope of the technical idea defined by the claims.

### INDUSTRIAL APPLICABILITY

The magnetic coupling device for magnetic coupling circuit components or the like according to the present invention is used for prevention of forgery of banknotes and other purposes.

### BRIEF DESCRIPTION OF THE DRAWINGS

FIG. 1 is an oblique cross-sectional view of an RF-powder-containing base.

FIG. 2 is an oblique view showing an example of an RF powder particle contained in an RF-powder-containing base.

FIG. 3 is a plan view of the RF powder particle.

FIG. 4 is a cross-sectional view showing the cross-section along the line A-A in FIG. 3.

FIG. 5 is a cross-sectional view showing the cross-section along the line B-B in FIG. 3.

FIG. 6 is a configuration view showing a device configuration used to inspect an RF-powder-containing base.

FIG. 7 is a side view illustrating magnetic coupling using high-frequency electromagnetic fields that occurs when a reader inspects an RF-powder-containing base.

FIG. 8 is a diagram showing a two-way transmission relationship between an RF powder particle and a reader via a high-frequency magnetic field at the position of the RF powder particle.

FIG. 9 is an oblique view of a scanning probe illustrating the first embodiment of the magnetic coupling device (scanning probe) and the reading device (reader) according to the present invention.

FIG. 10 is a cross-sectional view showing important components of the scanning probe according to the first embodiment.

FIG. 11 is a plan view of the foreside of the scanning probe according to the first embodiment.

FIG. 12 is an enlarged view of the foreside of a dielectric substrate mounted on the scanning probe according to the first embodiment.

FIG. 13 is an enlarged perspective view of the backside of the dielectric substrate of the scanning probe according to the first embodiment seen from the foreside.

FIG. 14 is a plan view of a scanning probe illustrating the second embodiment of the magnetic coupling device (scanning probe) and the reading device (reader) according to the present invention.

FIG. 15 is a plan view of the foreside of the first substrate layer of the scanning probe according to the second embodiment.

FIG. 16 is a perspective view of the backside of the first substrate layer of the scanning probe according to the second embodiment seen from the foreside.

FIG. 17 is a plan view of the foreside of the second substrate layer of the scanning probe according to the second embodiment.

FIG. 18 is a perspective view of the backside of the second substrate layer of the scanning probe according to the second embodiment seen from the foreside.

FIG. 19 is a plan view of a scanning probe illustrating the third embodiment of the magnetic coupling device (scanning probe) and the reading device (reader) according to the present invention.

FIG. 20 is a plan view of a scanning probe illustrating the fourth embodiment of the magnetic coupling device (scanning probe) and the reading device (reader) according to the present invention.

FIG. 21 is a plan view of a scanning probe illustrating the fifth embodiment of the magnetic coupling device (scanning probe) and the reading device (reader) according to the present invention.

FIG. 22 is an elevation view of a ten-thousand-yen banknote to which a plurality of RF powder particles are added.

FIG. 23 is an oblique view of a reader illustrating another embodiment of the magnetic coupling device (scanning probe) and the reading device (reader) according to the present invention.

FIG. 24 includes diagrams showing variations of the reader according to the embodiment described above.

FIG. 25 is an oblique view showing an example of known noncontact IC card reading devices.

FIG. 26 is an enlarged oblique view showing a configuration of a known noncontact IC card.

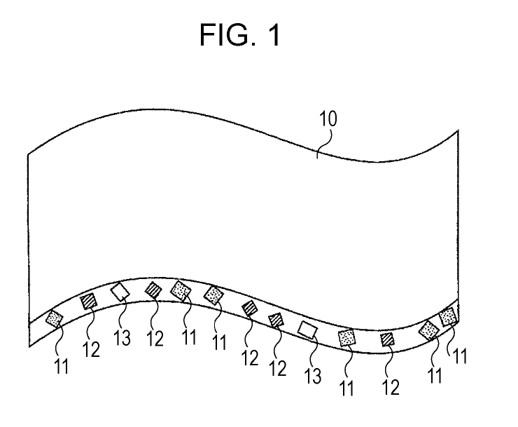

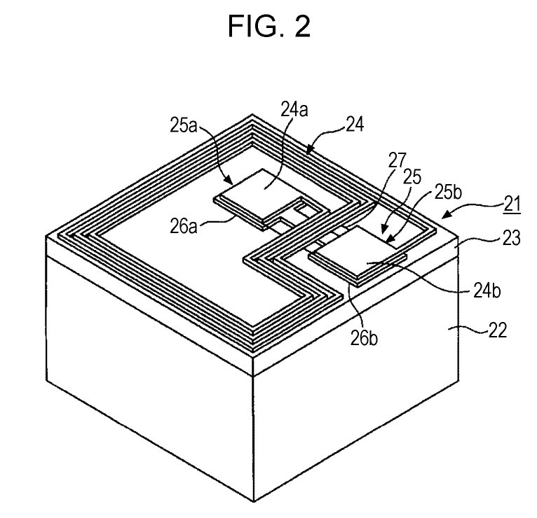

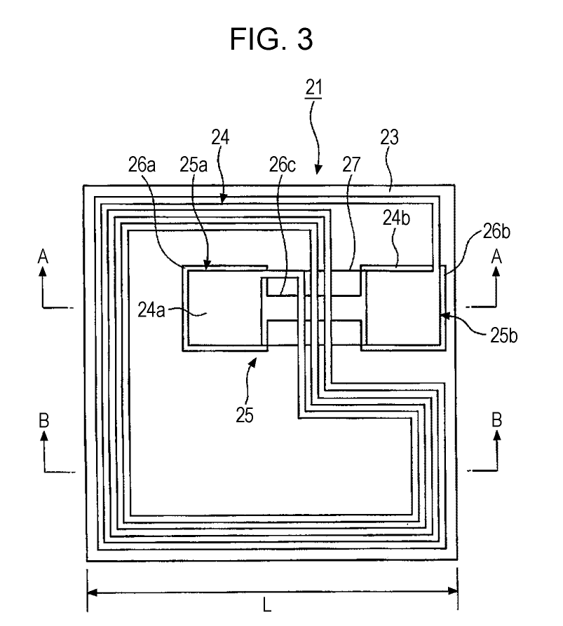

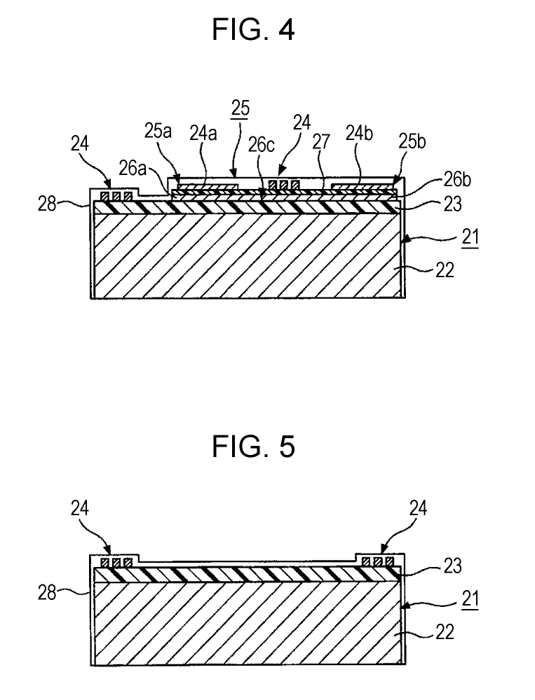

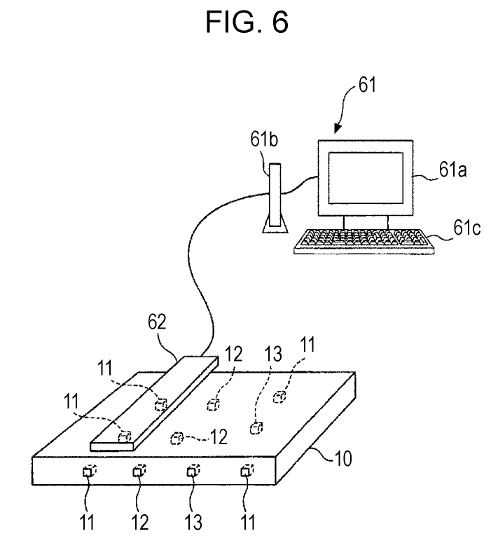

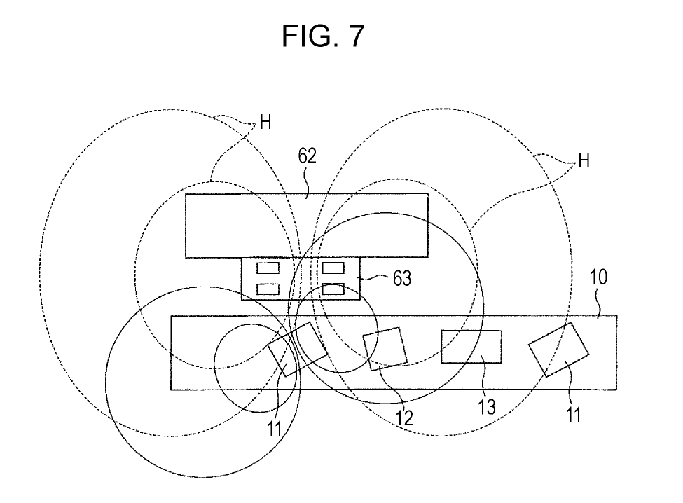

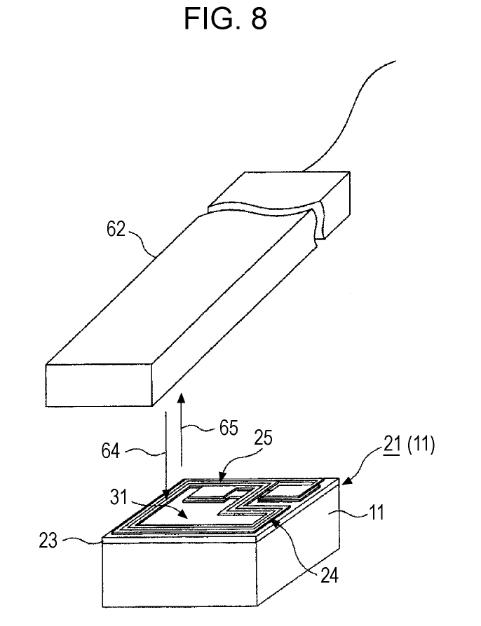

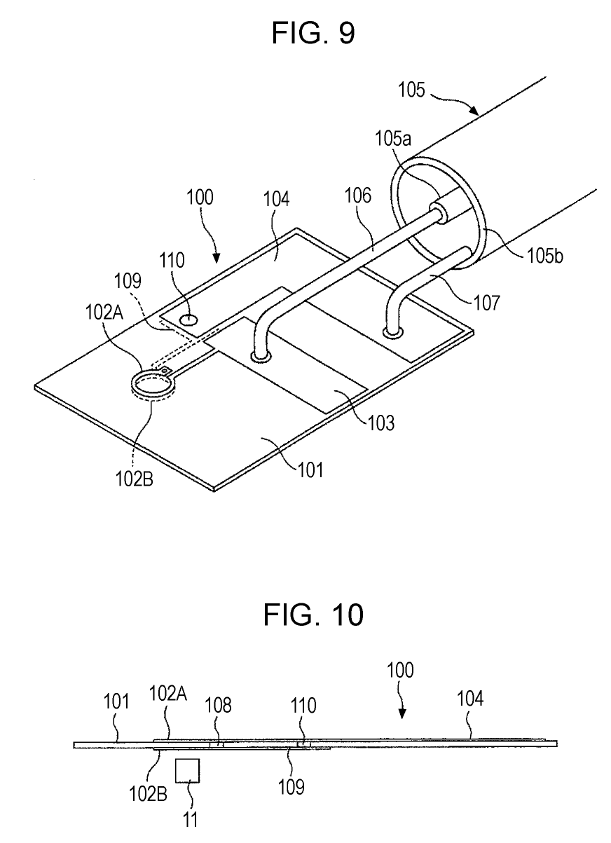

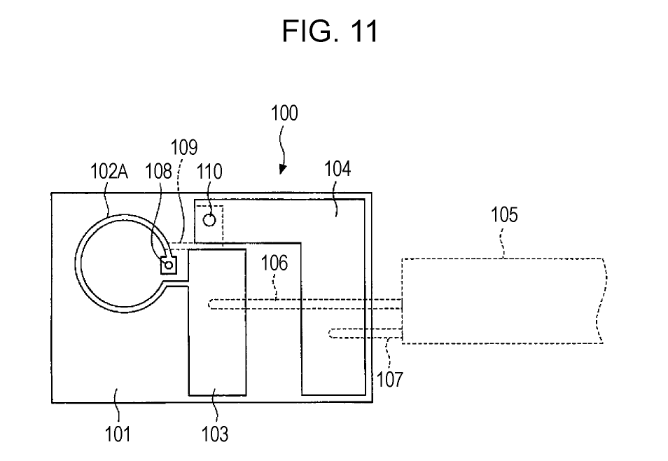

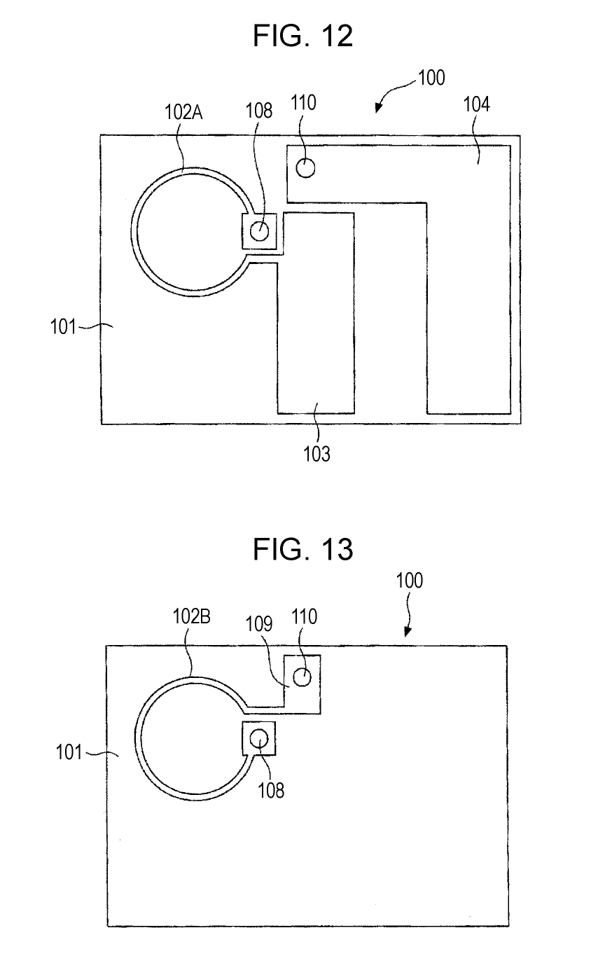

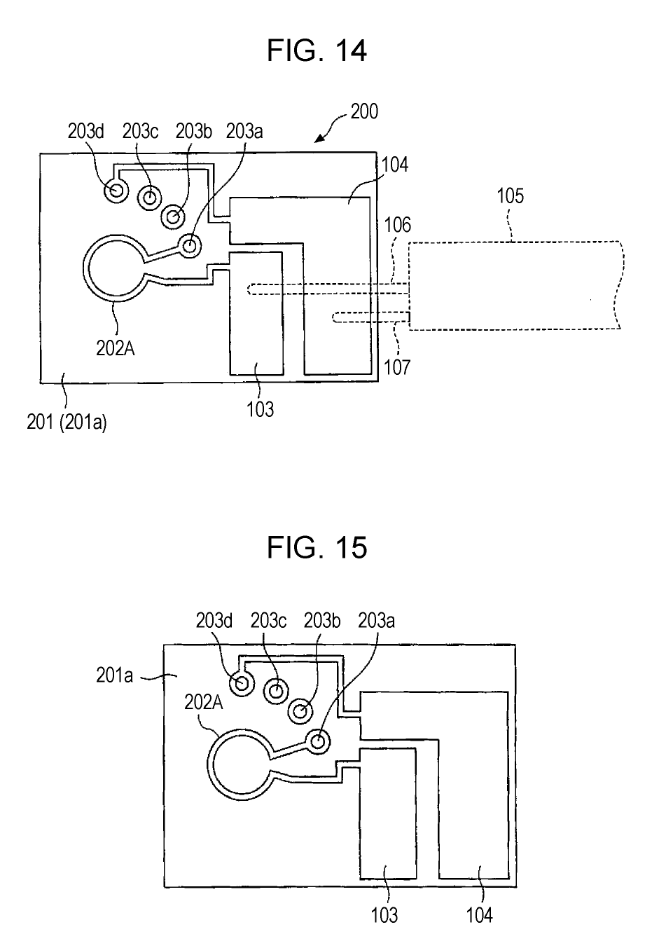

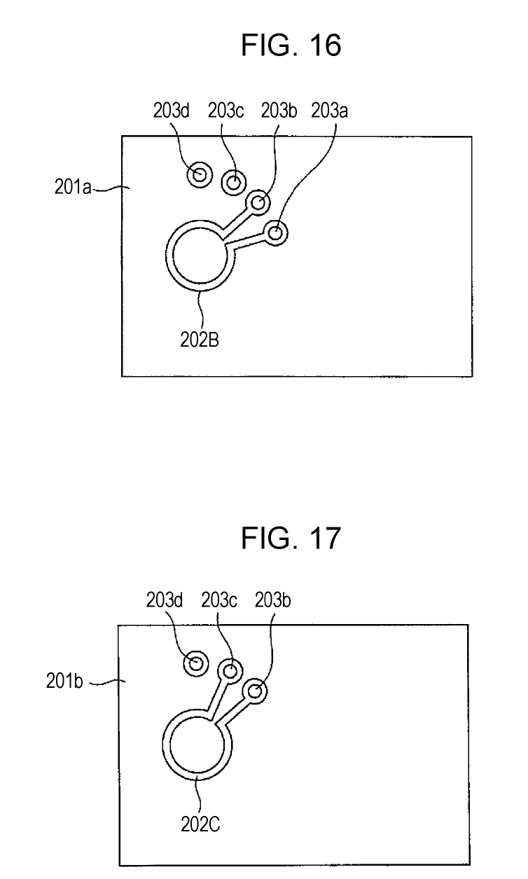

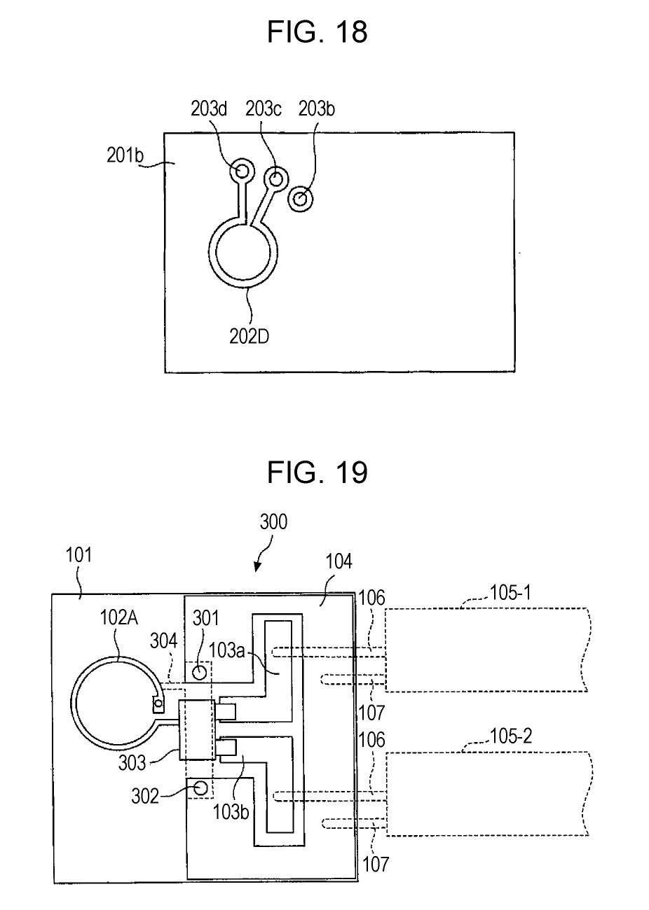

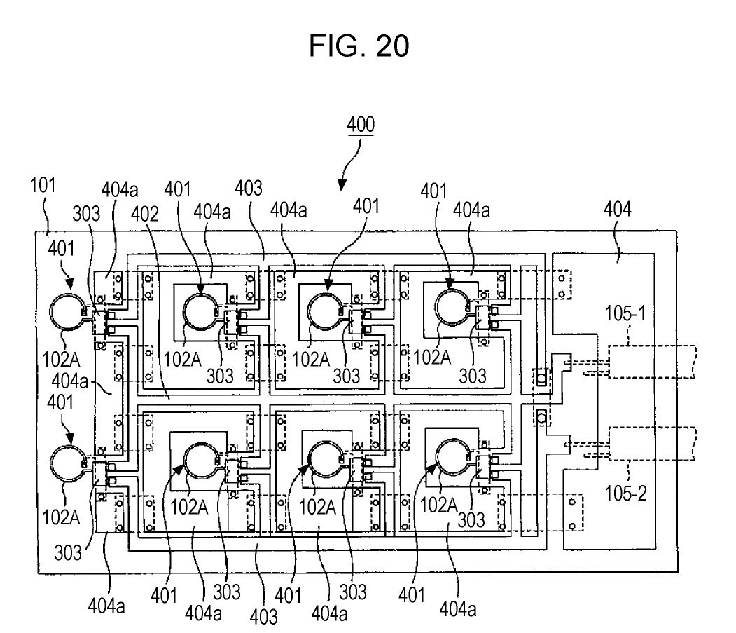

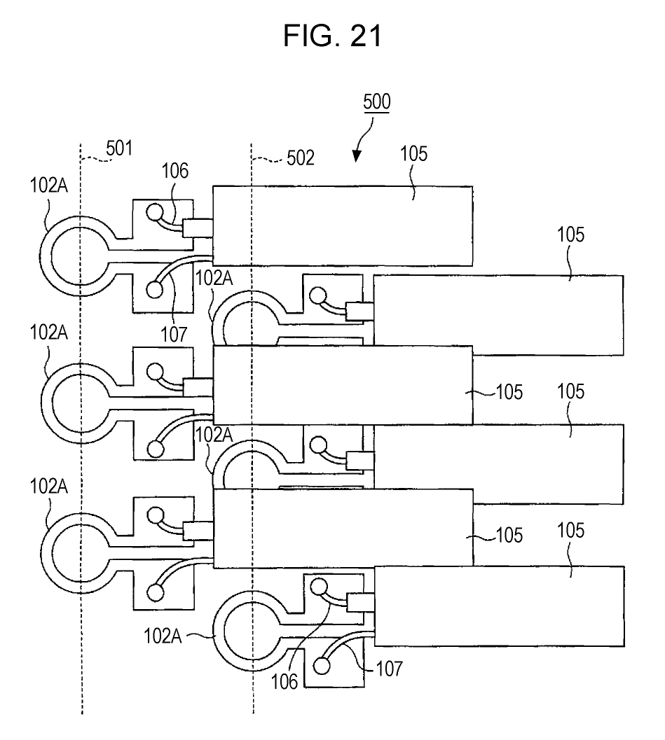

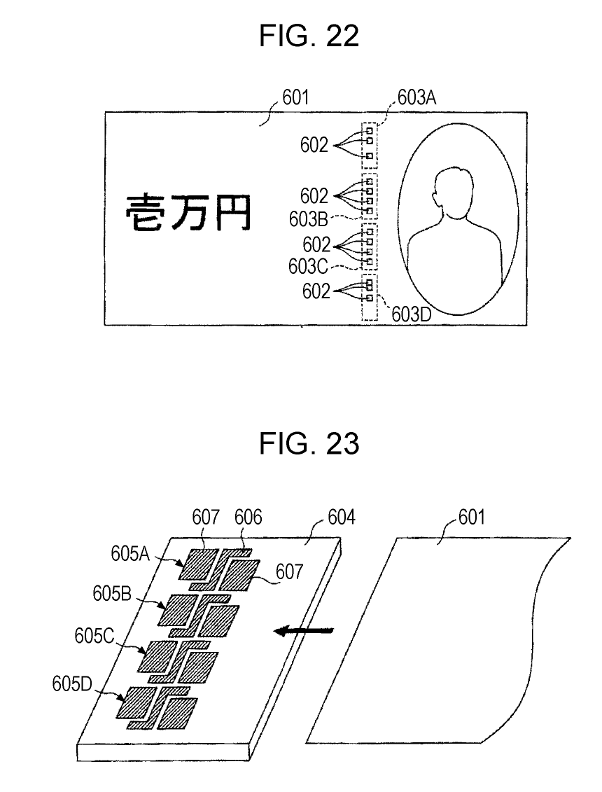

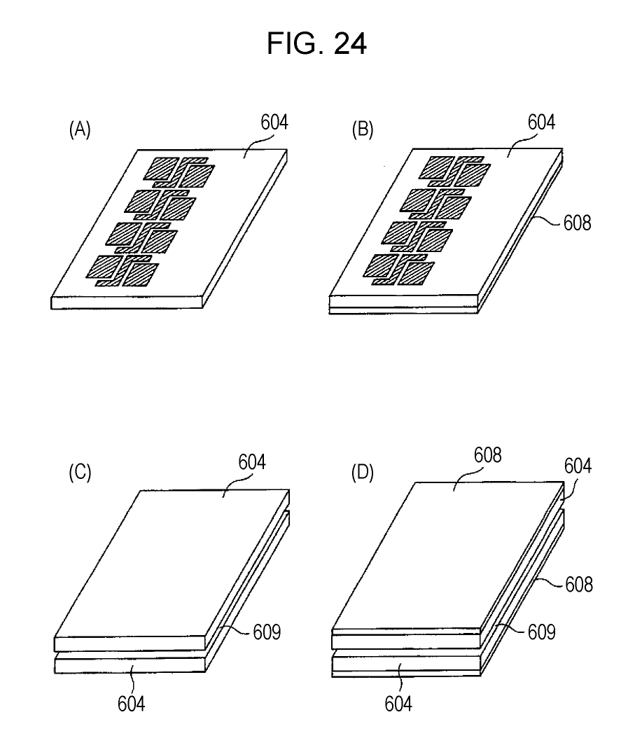

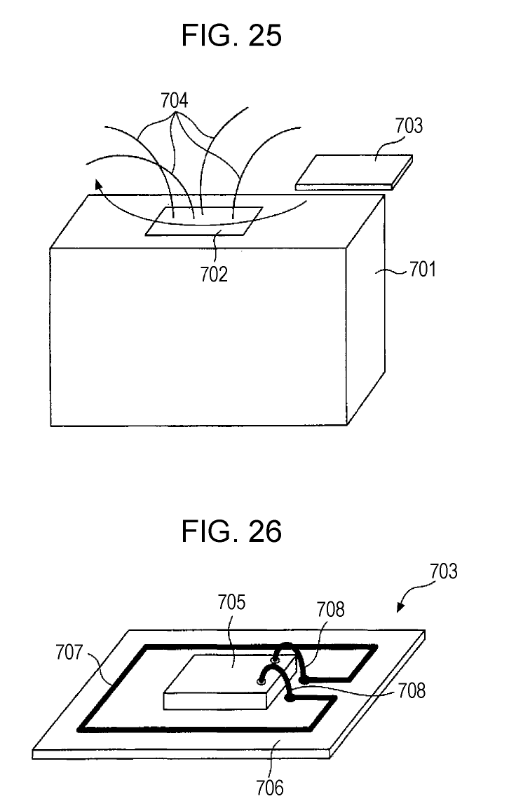

### REFERENCE NUMERALS

10 RF-powder-containing base (e.g., a banknote)

11, 12, 13 RF powder particle

21 RF powder particle

22 substrate

23 insulating layer

24 coil

25 condenser (capacitor)

27 insulating film

31 tank circuit

62 reader

63 scanning probe

100 scanning probe

101 dielectric substrate

102A, 102B electromagnetic loop pattern

105 coaxial line

200 to 500 scanning probe

602 RF powder particle

603A to 603D sector

604 reader

605a to 605D transmission line sector monitor

1. A magnetic coupling device comprising a loop antenna for generation of a high-frequency electromagnetic field that resonates with a tank circuit, wherein the loop antenna has:
a dielectric substrate;
a first loop antenna formed on a foreside of the dielectric substrate;
a second loop antenna formed on a backside of the dielectric substrate so as to be located in the same position and have the same diameter as the first loop antenna; and
a junction connecting the first loop antenna and the second loop antenna in
series.

2. The magnetic coupling device according to claim 1, wherein the foreside of the dielectric substrate has a first terminal pattern to which a signal line conductor of a power feeder is connected and a second terminal pattern to which an earth conductor of the power feeder is connected; and
the first terminal pattern is connected to an input terminal of the first loop antenna and the second terminal pattern is connected to an output terminal of the second loop antenna through a through hole.

3. The magnetic coupling device according to claim 1, wherein the first loop antenna and the second loop antenna have a helical structure.

4. The magnetic coupling device according to claim 1, wherein a plurality of antenna units each having the first loop antenna and the second loop antenna are arranged on the foreside of the dielectric substrate.

5. The magnetic coupling device according to claim 4, wherein the antenna units are arranged on the foreside of the dielectric substrate in such a manner that monitoring areas of the individual antenna units have no gap therebetween in the direction of arrangement.

6. The magnetic coupling device according to claim 1, wherein the diameter of the first loop antenna and the second loop antenna is almost equal to the diameter of a magnetic coupling coil of the tank circuit.

7. A magnetic coupling device comprising a loop antenna that generates a high-frequency electromagnetic field for resonance with a tank circuit, wherein the loop antenna has:
a bilayer dielectric substrate having a first substrate layer and a second substrate layer;
a first loop antenna formed on a foreside of the first substrate layer;
a second loop antenna formed on a backside of the first substrate layer;
a third loop antenna formed on a foreside of the second substrate layer;
a fourth loop antenna formed on a backside of the second substrate layer; and
a junction connecting the four loop antennas, i.e., the first to fourth loop antennas, in series; and
the four loop antennas, i.e., the first to fourth loop antennas, have the same diameter and are superposed on each other so as to be located at the same position.

8. The magnetic coupling device according to claim 7, wherein the foreside of the first substrate layer of the dielectric substrate has a first terminal pattern to which a signal line conductor of a power feeder is connected and a second terminal pattern to which an earth conductor of the power feeder is connected; and
the first terminal pattern is connected to an input terminal of the first loop antenna and the second terminal pattern is connected to an output terminal of the fourth loop antenna through a through hole.

9. The magnetic coupling device according to claim 7, wherein the four loop antennas, i.e., the first to fourth loop antennas, have a helical structure.

10. The magnetic coupling device according to claim 1, wherein the foreside of the dielectric substrate has a first transmitting terminal pattern to which a signal line conductor of a transmitting power feeder is connected, a first receiving terminal pattern to which a signal line conductor of a receiving power feeder is connected, and a second terminal pattern to which an earth conductor of the transmitting power feeder and an earth conductor of the receiving power feeder are connected; and
any of the first transmitting terminal pattern and the first receiving terminal pattern is connected to an input terminal of the first loop antenna via a switch and the second terminal pattern is connected to an output terminal of the second loop antenna through a through hole.

11. A magnetic coupling device comprising:
means for generating a high-frequency magnetic field resonating with and sensing a tank circuit built into each of a plurality of magnetic coupling circuit components, the magnetic coupling circuit components being added to a sheet member with a plurality of sectors and corresponding to the sectors; and
a plurality of transmission line sector monitors arranged on a foreside of a dielectric plate substrate in a line, wherein:
each of the transmission line sector monitors has a transmission line pattern and an earth pattern formed on the foreside of the dielectric substrate.

12. The magnetic coupling device according to claim 11, wherein the sheet member is a banknote.

13. A reading device comprising the magnetic coupling device according to claim 1 as a scanning probe, wherein the reading device reads frequency information from a monitoring object having a magnetic coupling circuit component with the use of resonance caused by the scanning probe.
